(19) United States
(12) Patent Application Publication
(10) Pub. No.: US 2026/0313139 A1
(43) Pub. Date: Oct. 8, 2026

(54) METHOD FOR ENCODING/DECODING FEATURE MAP AND RECORDING MEDIUM STORING INSTRUCTIONS THEREFOR

(71) Applicants: Electronics and Telecommunications Research Institute, Daejeon (KR); UNIVERSITY-INDUSTRY COOPERATION GROUP OF KYUNG HEE UNIVERSITY, Yongin-si (KR)

(72) Inventors: JooYoung LEE, Daejeon (KR); Se Yoon JEONG, Daejeon (KR); Youn Hee KIM, Daejeon (KR); Jung Won KANG, Daejeon (KR); Hui Yong KIM, Yongin-si (KR); Hye Won JEONG, Yongin-si (KR)

(73) Assignees: Electronics and Telecommunications Research Institute, Daejeon (KR); UNIVERSITY-INDUSTRY COOPERATION GROUP OF KYUNG HEE UNIVERSITY, Yongin-si (KR)

(21) Appl. No.: 19/632,596

(22) Filed: Mar. 30, 2026

(30) Foreign Application Priority Data
Mar. 28, 2025 (KR) 10-2025-0039932
Apr. 3, 2025 (KR) 10-2025-0043209
Jun. 9, 2025 (KR) 10-2025-0074419
Mar. 27, 2026 (KR) 10-2026-0055877

(51) Int. Cl. H04N 19/172; H04N 19/136; H04N 19/463

(52) U.S. Cl. CPC H04N 19/172; H04N 19/136; H04N 19/463

(57) ABSTRACT

According to a method of decoding a feature map, the method comprising restoring a truncated reduced feature map by performing format inverse-conversion on a picture decoded from a bitstream; and restoring a feature map from the truncated reduced feature map, wherein the format inverse-conversion comprises at least one of an inverse-normalization or a distribution compensation on a decoded picture.

### BACKGROUND OF THE INVENTION

### Field of the Invention

The present disclosure relates to a method and a device for encoding/decoding a feature map.

### Description of the Related Art

A traditional image compression technology has been developed to ensure that when a compressed image is reconstructed, a reconstructed image is as similar as possible to the original based on human vision. In other words, an image compression technology has been developed towards minimizing a bit rate and maximizing the image quality of a reconstructed image at the same time.

As an example, an encoder receives an image as input to generate a bitstream through a transform and entropy encoding process for an input image, and a decoder receives a bitstream as input to reconstruct it to an image similar to the original.

To measure similarity between an original image and a reconstructed image, an objective image quality evaluation scale or a subjective image quality evaluation scale may be used. Here, Mean Squared Error (MSE), etc. which measures a difference in pixel values between an original image and a reconstructed image is mainly used as an objective image quality evaluation scale. Meanwhile, a subjective image quality evaluation scale means that a person evaluates a difference between an original image and a reconstructed image.

Meanwhile, as machine vision working performance has been improved, a growing number of machines, instead of persons, have watched and consumed an image. As an example, in fields such as a smart city, an autonomous car, an airport surveillance camera, etc., an increasing number of images are used based on machines, not persons.

Accordingly, recently, other than traditional image compression focusing on persons, there is a growing interest in an image compression technology centered on machine vision.

### SUMMARY OF THE INVENTION

It is an object of the present disclosure to provide a method of encoding/decoding distribution parameters and/or normalization parameters.

It is a further object of the present disclosure to provide a method of reusing distribution parameters and/or normalization parameters of a previous picture during encoding/decoding a feature map.

It is a further object of the present disclosure to provide a method of deriving distribution parameters and/or normalization parameters through syntax signaled at the FSPS level and syntax signaled at the FPPS level.

The technical problems to be achieved by the present disclosure are not limited to the technical problems mentioned above, and other technical problems not mentioned herein may be clearly understood by those skilled in the art from the description below.

In accordance with an aspect of the present disclosure, the above and other objects can be accomplished by the provision of a method of decoding a feature map, the method comprising restoring a truncated reduced feature map by performing format inverse-conversion on a picture decoded from a bitstream; and restoring a feature map from the truncated reduced feature map. Here, the format inverse-conversion comprises at least one of an inverse-normalization or a distribution compensation on a decoded picture.

In the method of decoding a feature map according to the present disclosure, the inverse-normalization is performed based on a normalization parameter, and the normalization parameter comprises a maximum value and a minimum value of feature values.

In the method of decoding a feature map according to the present disclosure, a first update flag indicates whether the normalization parameter needs to be updated is decoded from the bitstream.

In the method of decoding a feature map according to the present disclosure, in response to the first update flag indicating that the normalization parameter does not need to be updated, a normalization parameter of a previous picture is used as the normalization parameter of the decoded picture.

In the method of decoding a feature map according to the present disclosure, in response to the first update flag indicating that the normalization parameter needs to be updated, a second update flag indicating whether only one of the maximum value and the minimum value needs to be updated is decoded from the bitstream, and in response to the second update flag indicating that only one of the maximum value and the minimum value needs to be updated, information specifying an updated value is further decoded from the bitstream.

In the method of decoding a feature map according to the present disclosure, in response to the updated value is greater than a maximum value of a previous picture, the updated value is set as an updated maximum value, and in response to the updated value is not greater than the maximum value of the previous picture, the updated value is set as an updated minimum value.

In the method of decoding a feature map according to the present disclosure, each of a maximum value update flag indicates whether the maximum value needs to be updated and a minimum value update flag indicates whether the minimum value needs to be updated is decoded from the bitstream.

In the method of decoding a feature map according to the present disclosure, the maximum value update flag and the minimum value update flag are decoded from the bitstream when the decoded picture is not random access picture.

In the method of decoding a feature map according to the present disclosure, in response to the maximum update flag indicating that the maximum value does not need to be updated, the inverse normalization is performed based on a maximum value of a previous picture, and in response to the maximum update flag indicating that the maximum value needs to be updated, information indicating an updated maximum value is additionally decoded, and the inverse normalization is performed based on a maximum value indicated by the information.

In the method of decoding a feature map according to the present disclosure, in response to the minimum update flag indicating that the minimum value does not need to be updated, the inverse normalization is performed based on a minimum value of a previous picture, and in response to the minimum update flag indicating that the minimum value needs to be updated, information indicating an updated minimum value is additionally decoded, and the inverse normalization is performed based on a minimum value indicated by the information.

In the method of decoding a feature map according to the present disclosure, the maximum value and the minimum value have equal absolute values and opposite signs.

In the method of decoding a feature map according to the present disclosure, the distribution compensation is performed based on a distribution parameter, and the distribution parameter comprises a mean value and a standard deviation of feature values.

In the method of decoding a feature map according to the present disclosure, in response to a first distribution compensation flag decoded from an FSPS (Feature Sequence Parameter Set) indicating that the distribution compensation is performed, a distribution compensation flag indicating whether the distribution compensation is performed or not is further decoded from an FPPS (Feature Picture Parameter Set).

In the method of decoding a feature map according to the present disclosure, in response to the second distribution compensation flag indicates that the distribution compensation is performed, mean value information indicating the mean value and standard deviation information indicating the standard deviation are further decoded.

In the method of decoding a feature map according to the present disclosure, in response to a first distribution compensation flag decoded from an FSPS (Feature Sequence Parameter Set) indicating that the distribution compensation is performed, a present flag indicating whether distribution compensation parameter information is present in an FPPS (Feature Picture Parameter Set) or not is decoded.

In the method of decoding a feature map according to the present disclosure, in response to the present flag indicating that the distribution compensation parameter information is not present in the FPPS, the distribution compensation is performed based on a default distribution compensation.

In accordance with an aspect of the present disclosure, the above and other objects can be accomplished by the provision of a method of encoding a feature map, the method comprising generating an encoding target picture by performing format conversion on a reduced feature map; and encoding the encoding target picture. Here, the format conversion comprises at least one of distribution adjustment or normalization on the reduced feature map.

Meanwhile, in the present disclosure, it is possible to provide a computer-readable recording medium recording instructions for implementing the method of decoding an image to perform a machine vision task.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is an example of the results of a machine task that perform object detection and classification using Fast R-CNN, one of artificial neural networks.

FIG. 2 is a diagram illustrating a multi-layer feature map.

FIG. 3 shows an artificial neural network model of the Mask-RCNN structure.

FIG. 4 illustrates an example where the feature map extraction unit and the task performing unit are present on different devices.

FIG. 5 is a block diagram of a feature map encoder and a feature map decoder according to an embodiment of the present disclosure.

FIGS. 6 to 9 illustrate examples of the configuration of a feature map reduction conversion unit.

FIGS. 10 to 14 illustrate examples of a configuration of a feature map reduction inverse conversion unit.

FIG. 15 illustrates another example of a configuration of the feature map reduction conversion unit.

FIG. 16 is a flowchart of a process for performing distribution compensation on a restored feature map or a restored reduced feature map in a decoder according to an embodiment of the present disclosure.

FIG. 17 is a flowchart of a process for performing inverse normalization on a reduced feature map restored in a decoder according to an embodiment of the present disclosure.

### DETAILED DESCRIPTION OF THE INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from another element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

Machine tasks based on image processing using artificial neural networks (ANNs) are getting widely used. For example, machine vision tasks such as object classification, object recognition, object detection, object segmentation, or object tracking from input images, or image processing tasks such as improving resolution of input images (super-resolution) or frame interpolation for input images are being increasingly utilized.

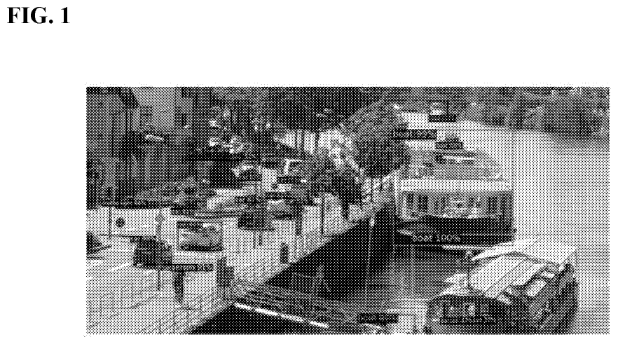

FIG. 1 is an example of the results of a machine task that perform object detection and classification using Fast R-CNN, one of artificial neural networks.

For the machine task described above, necessary of image compression technology for machine vision, not human vision, is hugely increased.

Image compression technology for machine vision minimizes the amount of compression bits, but unlike image compression technology for human vision, it has goals to maximize the performance of machine vision tasks through a restored feature map, not the image quality of restored images.

Meanwhile, an artificial neural network model that performs machine tasks may include a feature map extraction unit that extracts features from input data or input image, and a task performing unit that performs actual a machine task based on the extracted features.

When data input to an artificial neural network model is an image, the features extracted from the feature map extraction unit may be called a feature map. Accordingly, in this disclosure, the features extracted from the feature map extraction unit are called a ‘feature map.’ However, even when the extracted features are not in the form of a map, the embodiments described in this disclosure also may be applied.

The embodiments described in this disclosure may be applied to a multi-layer feature map.

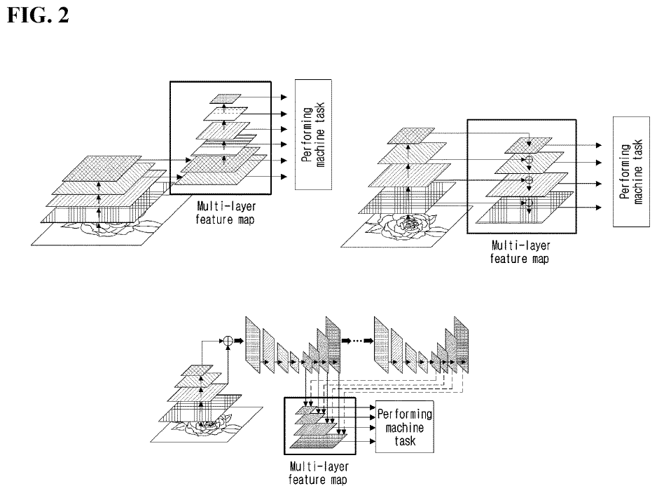

FIG. 2 is a diagram illustrating a multi-layer feature map.

The multi-layer feature map has a structure in which feature maps with different resolutions form multiple layers. A feature map in a higher layer has a lower resolution, and a feature map in a lower layer has a higher resolution. Accordingly, the multi-layer feature map may also be called a pyramid-structured feature map. Meanwhile, the resolutions of feature maps within the same layer may be mutually same.

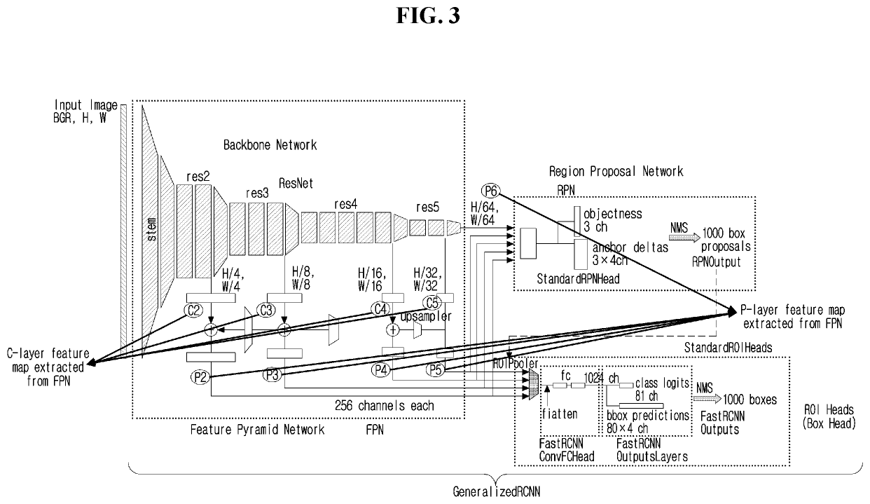

FIG. 3 shows an artificial neural network model of the Mask-RCNN structure.

The artificial neural network model of the Mask-RCNN structure illustrated in FIG. 3 may be mainly utilized for object region segmentation machine task.

In the example illustrated in FIG. 3, a feature pyramid network (FPN) corresponds to a multi-layer feature map extraction unit, and a region proposal network (RPN) and a region of interest heads (ROI Heads) correspond to a machine task performing unit.

In the example illustrated in FIG. 3, the feature pyramid network (FPN) is exemplified as extracting a C-layer feature map and a P-layer feature map. Here, each of the C-layer feature map and the P-layer feature map may be a multi-layer feature map.

The embodiments described below will be described with a focus on the P-layer feature map, but the embodiments described in the present disclosure may be equally applied to a feature map of a different type than the P-layer feature map. Meanwhile, the embodiments described in the present disclosure may be equally applied to not only multi-layer feature maps but also single-layer feature maps.

The feature map may be represented as a two-dimensional array. Accordingly, the size of the feature map can be defined as (width×height).

Meanwhile, a feature map belonging to an arbitrary layer can be composed of one or more channels. Accordingly, the feature map of each layer can be represented as a three-dimensional array having a size of (width×height×number of channels).

That is, when a feature map belonging to layer k is called Fₖ, the feature map Fₖ may be represented as a three-dimensional array Fₖ[x][y][c] composed of extracted feature values. Here, x and y represent the horizontal and vertical positions of a feature value, respectively, and c represents the channel index.

Meanwhile, as machine tasks are utilized not only on large servers but also on devices with relatively low computing power, such as mobile devices, cases where the feature map extraction unit and the task performing unit do not exist in the same device are becoming increasingly common.

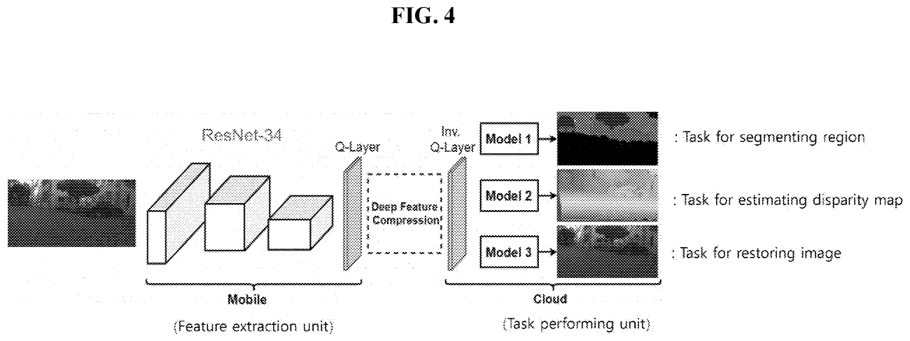

FIG. 4 illustrates an example where the feature map extraction unit and the task performing unit are present on different devices.

Specifically, in FIG. 4, the feature map extraction unit is shown as existing on a mobile device, while the machine task performing unit, which performs a machine task such as object segmentation, disparity map estimation, or image restoration, is shown as existing on a cloud server.

In this case, the feature map extracted from the mobile device is transmitted to the server, and the results of the task performing on the server may be fed back to the mobile device.

As shown in the example illustrated in FIG. 4, when the feature map extraction unit and the machine task execution unit are present in different devices, the extracted feature map should be transmitted to the machine task performing unit. Accordingly, a feature map encoding/decoding method may be required to minimize the amount of data of the feature map to be transmitted and stored, while simultaneously minimizing the degradation of task performing performance. Even if the feature map extraction unit and the task performing unit present in a single device, there may be cases where the extracted feature map is stored and subsequently utilized by the task execution unit. In this case as well, a feature map encoding/decoding method may be required to minimize the amount of data of the feature map to be stored.

Accordingly, the present disclosure proposes a method of encoding/decoding a feature map extracted by the feature map extraction unit.

Generally, a machine task model may be composed of a feature map extraction unit and a task performing unit.

In the present disclosure, the input signal I may be data including at least one of an image, voice, or text. Additionally, the machine task result P may be at least one of an image, voice, text, or machine task performance.

The input feature map X (X={x¹, . . . x^{k}}) may be composed of L layers (L is a natural number greater than or equal to 1). The restored feature map \hat{X} (\hat{X}={\hat{x}¹, . . . \hat{x}^{L}}) may also be composed of L layers.

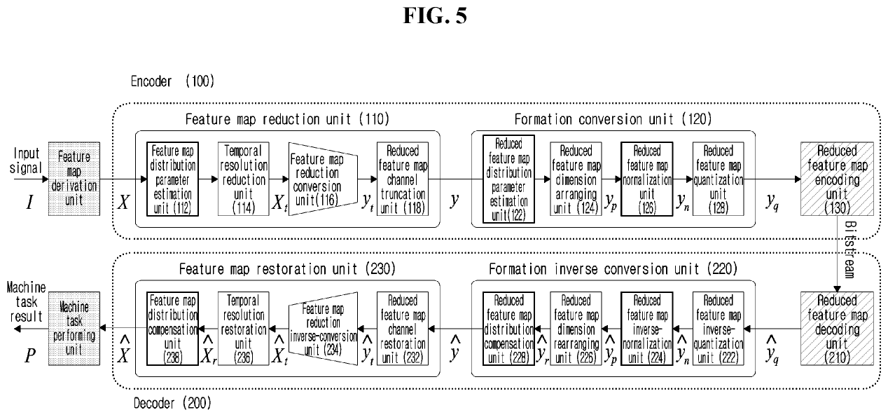

FIG. 5 is a block diagram of a feature map encoder and a feature map decoder according to an embodiment of the present disclosure.

Referring to FIG. 5, the feature map encoder 100 may include at least one of a feature map reduction unit 110, a format conversion unit 120), and a reduced feature map encoding unit 130, and the feature map decoder 200 may include at least one of a reduced feature map decoding unit 210 a format inverse conversion unit 220, and a feature map restoration unit 230.

Meanwhile, in FIG. 5, the data input to and output from each functional block may be as shown in Table 1 below.

TABLE 1

| Encoder | | Decoder | | Feature |
|---|---|---|---|---|
| Symbol | Description | Symbol | Description | Dimension |
| X | Input feature map (Intermediate | \hat{X} | Restored feature map | $X = {\{ {x}^{l} \}}_{l = 1}^{L}$ |
| | features) | | (Restored | |
| | | | intermediate | |
| | | | features) | |
| Xₜ | Feature map with reduced temporal | \hat{X}ᵣ | Restored feature map before | ${X}_{t} = {\{ {x}_{t}^{l} \}}_{n = 1}^{L}$ |
| | resolution | | compensation | (The same as |
| | (Temporally Down- | | (Restored | the |
| | sampled feature) | | unrefined | intermediate |
| | | | intermediate | feature shape) |
| | | | features) | |
| | | \hat{X}ₜ | Restored invese- | |
| | | | converted | |
| | | | reduced feature | |
| | | | map | |
| | | | (Restored | |
| | | | temporally down- | |
| | | | sampled features) | |
| yₜ | Reduced feature | ŷₜ | Restored reduced | [Cₜ, Hₜ, Wₜ] |
| | map | | feature map | |
| | (Transformed | | (Restored | |
| | feature) | | transformed | |
| | | | feature) | |
| y | Truncated reduced | ŷ | Restored | [Cᵣ, Hₜ, Wₜ] |
| | feature map | | truncated reduced | |
| | (Reduced feature) | | feature map | |
| | | | (Restored | |
| | | | reduced feature) | |
| | | ŷᵣ | Restored reduced | |
| | | | feature map | |
| | | | before | |
| | | | compensation | |
| | | | (Restored | |
| | | | unrefined reduced | |
| | | | feature) | |
| yₚ | Dimension arranged | ŷₚ | Restored | [1, Hₚ, Wₚ] |
| | reduced feature | | dimension | |
| | map | | arranged reduced | |
| | (Packed feature) | | feature map | |
| | | | (Restored packed | |
| | | | feature) | |
| yₙ | Normalized reduced | ŷ_{q} | Restored format | |
| | feature map | | converted | |
| | (Normalized | | reduced feature | |
| | feature) | | map | |
| y_{q} | Format converted | | (Restored | |
| | reduced feature | | quantized feature) | |
| | map | | | |
| | (Quantized feature) | | | |

The feature map reduction unit 110 may generate a truncated reduced feature map y from an input feature map X through feature map reduction. The feature map reduction unit 110 may include at least one of a feature map distribution parameter estimation unit 112, a temporal resolution reduction unit 114, a feature map reduction conversion unit 116, and a reduced feature map channel truncation unit 118.

The feature map distribution parameter estimation unit 112 estimates the distribution of the input feature map X and generates a distribution parameter. The distribution parameter may include at least one of the mean (i.e., average) or standard deviation of the feature values. The feature map distribution parameter estimation unit 112 may modify the distribution of the feature map X based on the distribution parameter. To perform the inverse process for modifying the feature map y, the distribution parameter estimated by the feature map distribution parameter estimation unit 112 may be encoded and signaled to a decoder.

The temporal resolution reduction unit 114 may reduce the temporal resolution of feature maps. Reducing the temporal resolution of the feature maps may include omitting encoding and decoding of a feature map corresponding to a specific picture order count (POC).

The feature map reduction conversion unit 116 may convert a feature map composed of L layers into a single layer feature map yₜ. The converted single-layer feature map yₜ may be referred to as a reduced feature map, and the reduced feature map may represent a latent vector, a latent representation, or a latent feature map.

The reduced feature map channel truncation unit 118 may remove at least one channel of the reduced feature map yₜ. Meanwhile, information regarding the removed channels may be encoded and signaled. The reduced feature map with at least one channel removed may be referred to as the truncated reduced feature map y.

The format conversion unit 120 may generate a dimensionally arrayed reduced feature map y_{q} from a truncated reduced feature map y through format conversion. The format conversion unit 120 may include a reduced feature map distribution parameter estimation unit 122, a reduced feature map dimension arranging unit 124, a reduced feature map normalization unit 126, and a reduced feature map quantization unit 128.

The reduced feature map distribution parameter estimation unit 122 may estimate the distribution parameter of the input truncated reduced feature map y. The distribution parameter may include at least one of the mean (i.e., average) or standard deviation of the feature values.

The reduced feature map distribution parameter estimation unit 122 may modify the distribution of the truncated reduced feature map y based on the distribution parameter. To perform the inverse process for modifying the truncated reduced feature map y, the distribution parameter estimated by the reduced feature map distribution parameter estimation unit 122 may be encoded and signaled to a decoder.

The reduced feature map dimension arranging unit 124 may rearrange the channels of a channel-truncated reduced feature map y in a temporal, spatial, or spatiotemporal manner.

The reduced feature map normalization unit 126 may normalize the feature values in the feature map to have values between 0 and 1 based on the maximum and minimum values of the channel-truncated feature map y (or the rearranged truncated reduced feature map yₚ). Meanwhile, to perform denormalization in the decoder, information indicating the maximum and minimum values in the channel-truncated feature map may be encoded and signaled.

The reduced feature map quantization unit 128 may perform quantization so that the normalized reduced feature map yₙ has integer values. At this time, quantization may be performed after increasing the range of values of the normalized reduced feature map yₙ to match the bit depth used by the reduced feature map encoding unit and the reduced feature map decoding unit.

In the reduced feature map encoding unit 130, a bitstream may be generated by encoding a dimensionally arrayed reduced feature map y_{q}.

In the reduced feature map decoding unit 210, the bitstream may be decoded to restore a dimensionally arrayed reduced feature map ŷₚ.

The format inverse conversion unit 220 may restore a reduced feature map f from the restored dimensionally arrayed reduced feature map ŷ, through format inverse conversion. The format inverse conversion unit 220 may include a reduced feature map inverse quantization unit 222, a reduced feature map inverse normalization unit 224, a reduced feature map dimension rearranging unit 226, and a reduced feature map distribution compensation unit 228.

The reduced feature map inverse quantization unit 222 performs the inverse process of quantization performed by the reduced feature map quantization unit 128 of the encoder. Through inverse quantization, a normalized reduced feature map ŷₙ, in which feature values exist within a range between 0 and 1, may be restored.

In the reduced feature map denormalization unit 224, denormalization may be performed on the normalized reduced feature map in which feature values exist within a range between 0 and 1. Specifically, the minimum and maximum values of the reduced feature map used in the reduced feature map normalization unit 126 may be singled from the encoder, and denormalization may be performed based on the signaled minimum and maximum values.

In the reduced feature map dimension rearrangement unit 226, the inverse process of what was performed in the reduced feature map dimension arranging unit 124 of the encoder is performed.

The reduced feature map distribution compensation unit 228 may perform distribution compensation for the reduced feature map based on a distribution parameter signaled from the encoder. The distribution parameter may include at least one of the mean or standard deviation of the feature values. Meanwhile, distribution compensation and denormalization for the reduced feature map ŷrovide similar effects. Accordingly, when distribution compensation for the reduced feature map is performed in the decoder, denormalization for the reduced feature map may not be performed.

To this end, information indicating whether distribution compensation for the reduced feature map should be performed in the encoder may be encoded and signaled. If the information indicates that distribution compensation should be performed for the reduced feature map, information for denormalization (i.e., information on maximum and minimum values) is not encoded/decoded, and information for distribution compensation (i.e., distribution parameters) may be encoded/decoded.

On the other hand, if the information indicates that distribution compensation is not performed for the reduced feature map, information for denormalization may be encoded/decoded.

The feature map restoration unit 230 may restore the feature map X from the restored reduced feature map f through feature map restoration.

The feature map restoration unit 230 may include a reduced feature map channel restoration unit 232, a feature map reduction inverse conversion unit 234, a temporal resolution restoration unit 236, and a feature map distribution compensation unit 238.

In the reduced feature map channel restoration unit 232, removed channels may be restored so that the number of channels of the restored reduced feature map becomes equal to the number of channels of the original feature map.

In the feature map reduction inverse conversion unit 234, a feature map having L layers may be restored from the restored reduced feature map.

When temporal resolution reduction is applied in the encoder, the temporal resolution restoration unit 236 may restore the temporal resolution of the feature maps. Specifically, through interpolation or extrapolation of the restored feature maps, a feature map on which encoding/decoding is omitted may be restored.

The feature map distribution compensation unit 238 may perform distribution compensation for the feature map based on distribution parameters signaled from the encoder. The distribution parameter may include at least one of the mean or standard deviation of the feature values.

The reduced feature map encoding unit 130 and the reduced feature map decoding unit 210 may perform encoding/decoding of the input image based on a conventional standard image compression codec, such as HEVC or VVC, or a neural network-based codec.

Specifically, the reduced feature map encoding unit 130 can perform encoding on the format-converted reduced feature map.

The reduced feature map decoding unit 210 may decode the bitstream to restore the format-converted reduced feature map.

Meanwhile, if the reduced feature map encoding unit 130 and the reduced feature map decoding unit 210 use a neural network-based codec, the format conversion unit 120 and the format inverse conversion unit 220 may be omitted.

The feature map reduction conversion unit may be composed of one or more feature map reduction conversion blocks. Here, each feature map reduction conversion block may include at least one of a neural network block used in an artificial neural network-based image processing technique, a structure for applying a filtering technique for image processing, or a structure for applying a dimensionality reduction and dimensionality expansion technique.

Specifically, the feature map reduction conversion block may include at least one of a neural network structure, a nonlinear function, an element-wise arithmetic operation, a structure for downsampling, or a structure for upsampling.

The feature map reduction inverse conversion unit may be composed of one or more feature map reduction inverse conversion blocks. Here, each feature map reduction inverse conversion block may include at least one of a neural network block used in an artificial neural network-based image processing technique, a structure for applying a filtering technique for image processing, or a structure for applying a dimensionality reduction and dimensionality expansion technique.

Specifically, the feature map reduction inverse conversion block may include at least one of a neural network structure, a nonlinear function, an element-wise arithmetic operation, a structure for downsampling, or a structure for upsampling.

The neural network structure may include at least one of a convolution layer, a transposed convolution layer, a fully connected layer, or a vision transformer.

The nonlinear function may include at least one of a rectified linear unit (ReLU), a hyperbolic tangent (tanh), or a sigmoid function.

The element-wise arithmetic operation may include a residual (skip) connection.

The downsampling technique may include at least one of bilinear interpolation or bicubic interpolation.

The upsampling technique may include at least one of bilinear extrapolation or bicubic extrapolation.

Dimensionality reduction or dimensionality expansion may be performed on an input by adjusting a stride of a neural network structure (e.g., a convolution layer or a fully connected layer) or the number of nodes in a hidden layer. In particular, through the above method, a spatial resolution (horizontal size and vertical size) of the input may be increased or decreased.

In the following embodiments, (s↑) denotes a reduced feature map reduction conversion block or a feature map reduction inverse conversion block that increases the horizontal size and vertical size of an input by a factor of s, and (s↓) denotes a reduced feature map reduction conversion block or a feature map reduction inverse transform block that decreases the horizontal size and vertical size of an input by a factor of s.

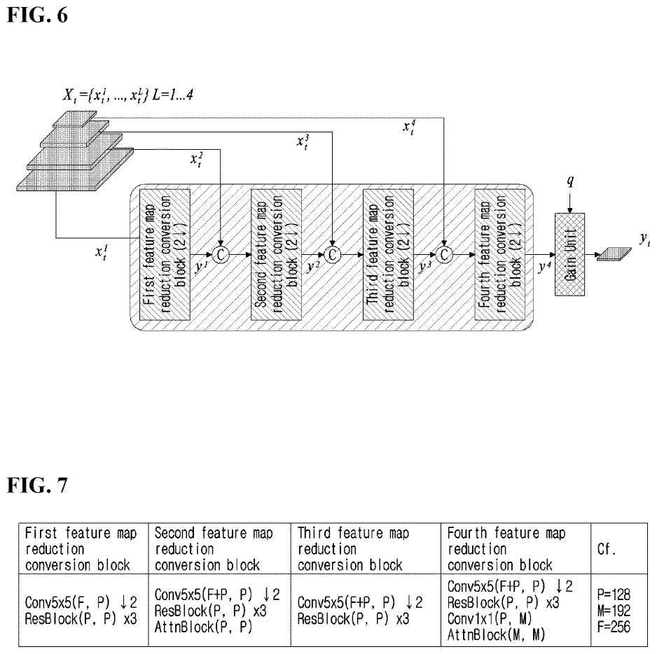

FIGS. 6 to 9 illustrate examples of the configuration of a feature map reduction conversion unit.

For convenience of explanation, it is assumed that a P-layer feature map (i.e.,

$${X}_{t} = {\{ {x}_{t}^{1} , ... , {x}_{t}^{L} \}}_{L = 1 ... 4} )$$

among the multi-layer feature maps is encoded.

FIG. 6 illustrates FENet (Fusion and Encoding Network) as an example of a feature map reduction conversion unit.

FENet may be composed of a series of feature map reduction conversion blocks. For example, FIG. 6 illustrates that FENet is composed of four feature map reduction conversion blocks.

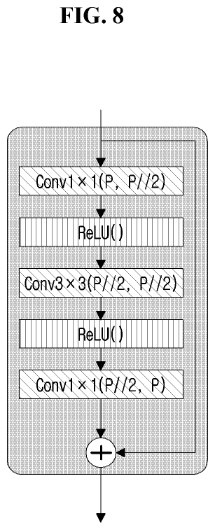

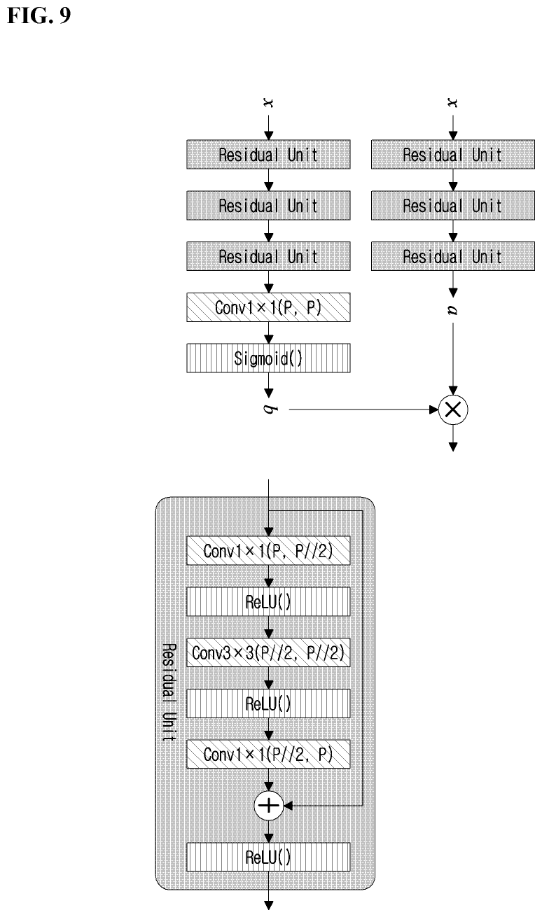

FIG. 7 illustrates a neural network block constituting each of the feature map reduction conversion blocks. FIG. 8 is a detailed view of the ResBlock(P, P) exemplified in FIG. 7, and FIG. 9 is a detailed view of the AttnBlock(P, P) exemplified in FIG. 7.

FENet may sequentially fuse and convert multilayer feature maps to output a reduced feature map yₜ. Meanwhile, in the example illustrated in FIG. 6, yⁱ may represent an intermediate latent feature map with index i.

The first feature map reduction conversion block receives the feature map x¹ₜ of the first layer (i.e., the layer with the smallest index) as input and may reduce the spatial resolution of the input feature map by ½ in each of a horizontal direction and a vertical direction. As a result, a first intermediate latent feature map y¹ with P channels and the same spatial resolution as the second layer may be output.

The second feature map reduction conversion block may receive, as an input, a channel-wise concatenation of the first intermediate latent feature map y¹ and a second-layer feature map x²ₜ having the same spatial resolution as the first intermediate latent feature map y¹, and may reduce the spatial resolution of the input by a factor of ½ in each of a horizontal direction and a vertical direction. As a result, a second intermediate latent feature map y² having the same spatial resolution as that of a third layer and having P channels may be output.

The third feature map reduction conversion block may receive, as an input, a channel-wise concatenation of the second intermediate latent feature map y² and a third-layer feature map x³ₜ having the same spatial resolution as the second intermediate latent feature map y², and may reduce the spatial resolution of the input by a factor of ½ in each of a horizontal direction and a vertical direction. As a result, a third intermediate latent feature map y³ having the same spatial resolution as that of a fourth layer and having P channels may be output.

The fourth feature map reduction conversion block may receive, as an input, a channel-wise concatenation of the third intermediate latent feature map y³ and a fourth-layer feature map x⁴ₜ having the same spatial resolution as the third intermediate latent feature map y³, and may reduce the spatial resolution of the input by a factor of ½ in each of a horizontal direction and a vertical direction. As a result, a fourth intermediate latent feature map y⁴ having P channels and having a spatial resolution reduced by a factor of ½ in each of the horizontal direction and the vertical direction with respect to the input may be output.

Meanwhile, an output of the fourth feature map reduction conversion block (i.e., the fourth intermediate latent feature map y⁴) may correspond to a reduced feature map yₜ. In addition, channel-wise scaling based on a gain unit may be further applied to the reduced feature map yₜ.

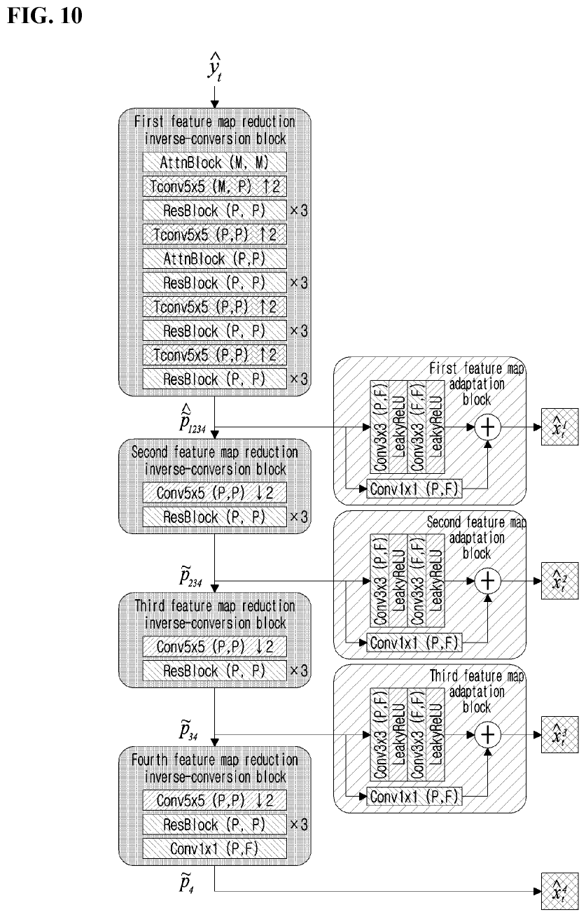

FIGS. 10 to 14 illustrate examples of a configuration of a feature map reduction inverse conversion unit.

For convenience of description, it is assumed that, based on a reconstructed reduced feature map ŷₜ, P-layer feature map

$${\hat{X}}_{t} = {\{ {\hat{x}}_{t}^{1} , ... , {\hat{x}}_{t}^{L} \}}_{L = 1 ... 4}$$

among multi-layer feature maps are decoded.

FIG. 10 illustrates, as an example of the feature map reduction inverse conversion unit, a DRNet (Decoding and Reconstruction Network).

The DRNet may be composed of a series of feature map reduction inverse conversion blocks and a plurality of feature map adaptation blocks. For example, in FIG. 10, the DRNet is illustrated as including four feature map reduction inverse conversion blocks and three feature map adaptation blocks.

The DRNet may sequentially perform inverse conversion on each layer of the multi-layer feature maps to reconstruct reduced inverse-converted feature maps

$${\hat{X}}_{t} ( {\hat{X}}_{t} = {\{ {\hat{x}}_{t}^{1} , ... , {\hat{x}}_{t}^{L} \}}_{L = 1 ... 4} ) .$$

That is, the DRNet may receive the reconstructed reduced feature map ŷₜ as an input and output reconstructed reduced inverse-converted feature maps \hat{X}ₜ. In addition, channel-wise scaling based on a gain unit may be further applied to the reconstructed reduced inverse-converted feature maps \hat{X}ₜ.

The first feature map reduction inverse conversion block may receive the reconstructed reduced feature map ŷₜ as an input and may output a first latent feature map \hat{\tilde{p}}₁₂₃₄ in which each of a horizontal direction and a vertical direction is expanded by a factor of 16.

The second feature map reduction inverse conversion block may receive the first latent feature map \hat{\tilde{p}}₁₂₃₄ as an input and may output a second latent feature map \hat{\tilde{p}}₂₃₄ in which each of a horizontal direction and a vertical direction is reduced by a factor of ½.

The third feature map reduction inverse conversion block may receive the second latent feature map \hat{\tilde{p}}₂₃₄ as an input and may output a third latent feature map \hat{\tilde{p}}₃₄ in which each of a horizontal direction and a vertical direction is reduced by a factor of ½.

The fourth feature map reduction inverse conversion block may receive the third latent feature map \hat{\tilde{p}}₃₄ as an input and may output a fourth latent feature map \hat{\tilde{p}}₄ in which each of a horizontal direction and a vertical direction is reduced by a factor of ½. The fourth latent feature map \hat{\tilde{p}}₄ may be a reconstructed reduced inverse-converted feature map

$${\hat{x}}_{t}^{4}$$

of a fourth layer.

The first feature map adaptation block may receive the first latent feature map \hat{\tilde{p}}₁₂₃₄ as an input and may output a reconstructed reduced inverse-converted feature map

$${\hat{x}}_{t}^{1}$$

of a first layer.

The second feature map adaptation block may receive the second latent feature map \hat{\tilde{p}}₂₃₄ as an input and may output a reconstructed reduced inverse-converted feature map

$${\hat{x}}_{t}^{2}$$

of a second layer.

The third feature map adaptation block may receive the latent feature map \hat{\tilde{p}}₃₄ as an input and may output a reconstructed reduced inverse-converted feature map

$${\hat{x}}_{t}^{3}$$

of a third layer.

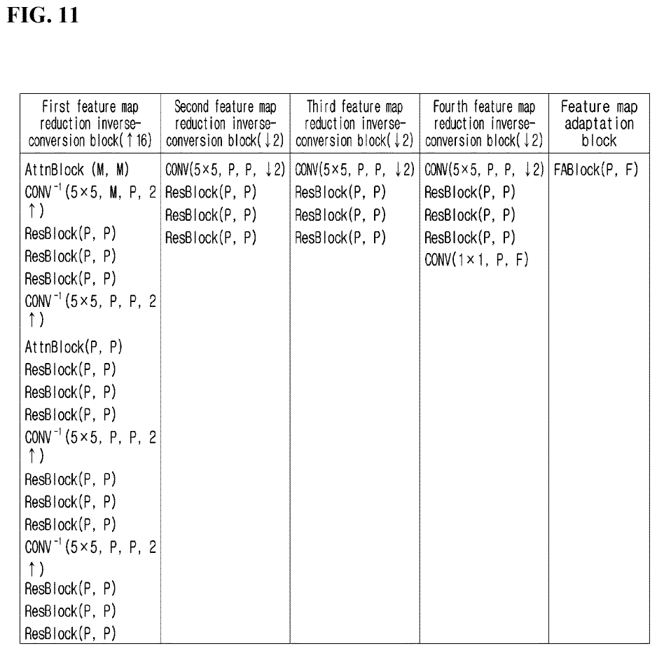

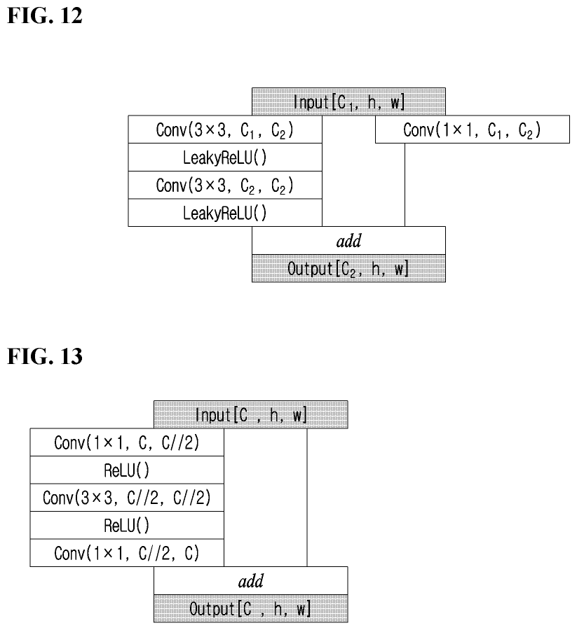

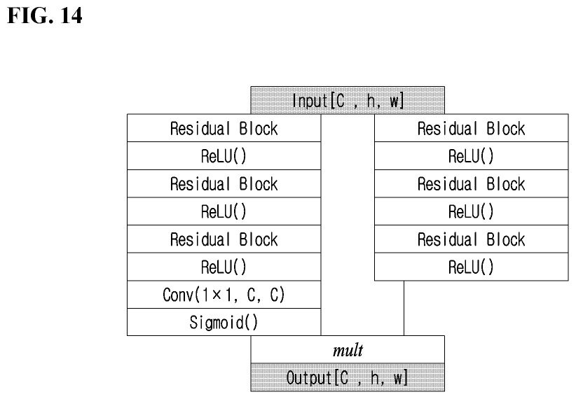

FIG. 11 illustrates neural network blocks constituting the feature map reduction inverse conversion blocks and the feature map adaptation blocks. FIG. 12 illustrates a detailed view of FAblock(P, f) shown in FIG. 11, FIG. 13 illustrates a detailed view of Resblock(P, P0) shown in FIG. 11, and FIG. 14 illustrates a detailed view of AttnBlock(P, P) shown in FIG. 11.

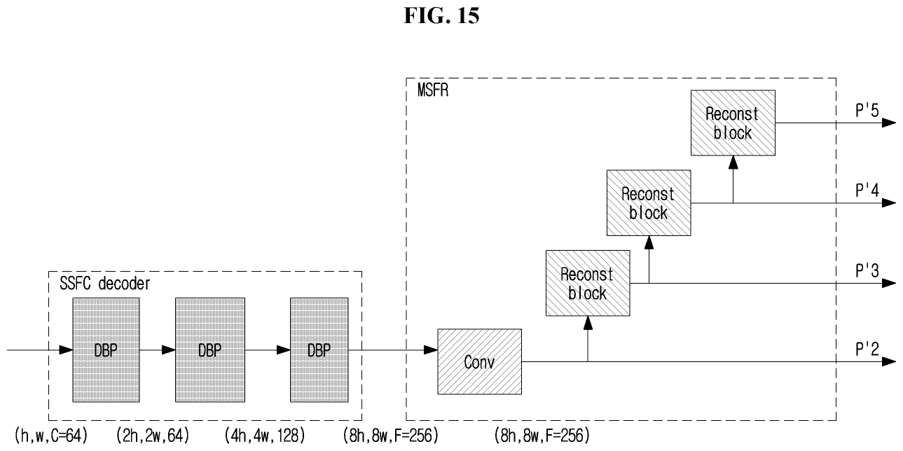

FIG. 15 illustrates another example of a configuration of the feature map reduction conversion unit.

For a specific encoding/decoding tool, an enablement flag (e.g., an enabled_flag) indicating whether the corresponding tool is allowed may be encoded and transmitted at a sequence parameter level (e.g., a Feature Sequence Parameter Set, FSPS), and parameters required for invocation of the corresponding encoding/decoding tool may be transmitted at a picture parameter level (e.g., a Feature Picture Parameter Set, FPPS). Specifically, when the enabled_flag for a specific tool transmitted in the FSPS is equal to 1, a present_flag indicating whether parameters of the specific tool are present in the FPPS may be encoded/decoded.

However, when the enabled_flag for the specific tool transmitted in the FSPS is equal to 1 while the present_flag indicating whether parameters of the specific tool are present in the FPPS is equal to 0, there may occur a problem in that it is unclear which parameters should be used to perform the specific tool in a current picture referring to the corresponding FPPS.

Accordingly, the present disclosure proposes an improved parameter encoding/decoding method. Here, the parameters may include at least one of distribution parameters for performing distribution compensation on a reconstructed feature map or a reconstructed reduced feature map, or normalization parameters for performing inverse normalization on the reconstructed reduced feature map.

### Embodiment 1) Encoding/Decoding of Distribution Parameters

The reduced feature map distribution parameter estimation unit estimates the distribution parameter of the input reduced feature map y, or the truncated reduced feature map y. The distribution parameter may include at least one of the mean or the standard deviation. Alternatively, the distribution parameter may further include at least one of the maximum value, the minimum value, the median, the variance, or the difference between the maximum and minimum values.

The mean μ and standard deviation a of the feature values may can be calculated by the following Equations 1 and 2.

$$μ = mean ( flatten ( y ) ) \qquad [ Equation 1 ]$$

$$σ = \sqrt{variance ( flatten ( y ) )} \qquad [ Equation 2 ]$$

The feature map distribution parameter estimation unit estimates distribution parameters for an input feature map X. At this time, when the number of layers L of the input feature map X is 1, the mean value and standard deviation of the feature values may be calculated based on Equations 1 and 2. On the other hand, when the number of layers L of the input feature map X is greater than 1, the mean value and standard deviation of the feature values may be calculated based on Equations 3 and 4.

$$μ = {\sum }_{l = 0}^{L} mean ( flatten ( {x}^{l} ) ) \qquad [ Equation 3 ]$$

$$σ = \sqrt{{\sum }_{l = 0}^{L} variance ( flatten ( {x}^{l} ) )} \qquad [ Equation 4 ]$$

Alternatively, when the number of layers L of the feature map is greater than 1, at least one of the Mean function, Variance function, or Z-Score Normalization function may be used to derive the mean and standard deviation for each layer of the feature map. Each of Equations 5 to 7 represents the Mean function, Variance function, and Z-Score Normalization function.

$$mean ( x ) = \frac{{\sum }_{i}^{‖ x ‖} x [ i ]}{‖ x ‖} \qquad [ Equation 5 ]$$

$$variance ( x ) = \frac{{\sum }_{i}^{‖ x ‖} {( x [ i ] - mean ( x ) )}^{2}}{‖ x ‖} \qquad [ Equation 6 ]$$

$$ZScoreNorm ( x ) = \hat{x} [ i ] = \frac{x [ i ] - mean ( x )}{√ variance ( x )} \qquad [ Equation 7 ]$$

In the reduced feature map distribution compensation unit, the distribution of the input reduced feature map ŷᵣ is compensated to restore the truncated reduced feature map ŷ. At this time, the reduced feature map distribution compensation unit may perform distribution compensation based on the distribution parameter signaled from the encoder.

Equation 8 shows an example in which the restored truncated reduced feature map ŷ is generated based on the distribution parameter.

$$\hat{y} = ZScroreNorm ( {\hat{y}}_{r} ) \times {\tilde{σ}}_{y} + {\tilde{μ}}_{y} \qquad [ Equation 8 ]$$

In Equation 8, p, represents the mean of the reduced feature map signaled from the encoder, and \tilde{σ}_{y}, represents the standard deviation of the reduced feature map signaled from the encoder.

The feature map distribution compensation unit performs distribution compensation on the input feature map \hat{X}ᵣ and outputs the restored feature map \hat{X}. Specifically, the feature map distribution compensation unit may perform distribution compensation based on distribution parameters signaled from the encoder.

The feature map distribution compensation unit may output the restored feature map \hat{X} (i.e., {\hat{x}¹, . . . \hat{x}^{L}}) based on Equation 9.

$${\hat{x}}^{l} = \frac{{x}_{r}^{l} - {μ}_{{x}_{r}}}{{σ}_{{x}_{r}}} \times {\tilde{σ}}_{x} + {\tilde{μ}}_{x} \qquad [ Equation 9 ]$$

In Equation 9, \tilde{μ}ₓ represents the mean of the feature map signaled from the encoder, and \tilde{σ}ₓ represents the standard deviation of the feature map signaled from the encoder.

Meanwhile, in Equation 9, μₓ_{ᵣ} and σₓ_{ᵣ} may be derived based on the following Equations 10 and 11.

$${μ}_{{x}_{r}} = {\sum }_{l = 0}^{L} mean ( flatten ( {x}_{r}^{l} ) ) \qquad [ Equation 10 ]$$

$${σ}_{{x}_{r}} = \sqrt{{\sum }_{l = 0}^{L} variance ( flatten ( {x}_{r}^{l} ) )} \qquad [ Equation 11 ]$$

At the sequence parameter level (e.g., FSPS, Feature Sequence Parameter Set), a flag indicating whether to perform distribution compensation may be encoded/decoded, and at the picture parameter level (e.g., FPPS, Feature Picture Parameter Set), distribution parameters for performing distribution compensation may be transmitted.

However, if the flag indicating whether to perform distribution compensation transmitted in the FSPS is 1, while the flag indicating whether a parameter for the specific tool is present in the FPPS is 0, a problem may occur where it is unclear which parameter should be used to perform the specific tool in the current picture referencing the FPPS.

To address the above problem, if enabled_flag is 1, which indicates whether a specific tool is allowed transmitted in the FSPS, the FPPS may be configured to always transmit a parameter for the specific tool.

Table 2 is an example of an FSPS structure containing a flag indicating whether to apply distribution compensation, and Table 3 is an example of an FPPS structure containing distribution parameters for distribution compensation.

TABLE 2

| | Descriptor |
|---|---|
| feature_seq_parameter_set_rbsp ( ) { | |
| fsps_feature_seq_parameter_set_id | |
| fsps_num_org_feature_layers | |
| for ( i = 0; i < fsps_num_org_feature_layers; i++ ) { | |
| fsps_org_feature_width[ i ] | |
| fsps_org_feature_height[ i ] | |
| fsps_org_feature_channel_count[ i ] | |
| } | |
| fsps_reduced_feature_width | |
| fsps_reduced_feature_height | |
| fsps_reduced_feature_channel_count | |
| inner_decoder_info( ) | |
| fsps_temporal_upsampling_enable_flag | u(1) |
| fsps_restored_feature_refine_enable_flag | u(1) |
| fsps_reduced_feature_refine_enable_flag | u(1) |
| fsps_channel_removal_enable_flag | u(1) |
| rbsp_trailing_bits( ) | |
| } | |

TABLE 3

| | Descriptor |
|---|---|
| feature_pic_parameter_set_rbsp( ) { | |
| fpps_feature_pic_parameter_set_id | |
| fpps_feature_seq_parameter_set_id | |
| if( fsps_restored_feature_refine_enable_flag ) { | |
| fpps_restored_feature_refine_present_flag | u(1) |
| if( fpps_restored_feature_refine_present_flag ) { | |
| fpps_restored_feature_std | bfloat(16) |
| fpps_restored_feature_mean | bfloat(16) |
| } | |
| } | |
| if( fsps_reduced_feature_refine_enable_flag ) { | |
| fpps_reduced_feature_refine_present_flag | u(1) |
| if ( fpps_reduced_feature_refine_present_flag ) { | |
| fpps_reduced_feature_std | float(32) |
| fpps_reduced_feature_mean | float(32) |
| } | |
| } | |
| if(fsps_feature_channel_removal_flag) { | |
| fpps_channel_removal_present_flag | u(1) |
| if( fpps_channel_removal_prsent_flag ) | |
| for( i=0; i<fsps_reduced_feature_channel_count; i++ ) | |
| fpps_coded_channel[ i ] | u(1) |
| } | |
| rbsp_trailing_bits( ) | |
| } | |

In FSPS, a flag indicating whether distribution compensation is applied to a feature map or a reduced feature map may be encoded/decoded.

For example, in Table 2, fsps_restored_feature_refine_enable_flag may indicate whether distribution compensation is performed on the feature map.

Specifically, fsps_restored_feature_refine_enable_flag being 1 indicates that performing distribution compensation on the restored feature map is enabled. Conversely, fsps_restored_feature_refine_enable_flag being 0 indicates that performing distribution compensation on the restored feature map is not enabled.

In Table 2, fsps_reduced_feature_refine_enable_flag may indicate whether distribution compensation is performed on the reduced feature map.

Specifically, fsps_reduced_feature_refine_enable_flag being 1 indicates that distribution compensation is enabled on the restored reduced feature map. Conversely, fsps_reduced_feature_refine_enable_flag being 0 indicates that distribution compensation is not enabled on the restored reduced feature map.

In FPPS, distribution parameters for distribution compensation may be encoded/decoded. In this case, distribution parameters for distribution compensation may be encoded/decoded via FPPS only if information in FPPS indicates that such parameters are present.

Meanwhile, fpps_restored_feature_std represents the standard deviation for performing distribution compensation on the restored feature map. Additionally, fpps_restored_feature_mean represents the mean value for performing distribution compensation on the restored feature map.

In Table 3, fpps_restored_feature_refine_present_flag indicates whether distribution parameters for distribution compensation for the restored feature map are present. For example, if fpps_restored_feature_refine_present_flag is 1, fpps_restored_feature_std and fpps_restored_feature_mean may be present in the FPPS. Additionally, if fsps_restored_feature_refine_enable_flag in the FSPS indicates that distribution compensation for the restored feature map is allowed, and fpps_restored_feature_refine_present_flag in the FPPS is 1, fpps_restored_feature_std and fpps_restored_feature_mean must be encoded/decoded.

Distribution compensation for the restored feature map may be performed based on the distribution parameters decoded from the FPPS.

In Table 3, fpps_restored_feature_refine_present_flag indicates whether distribution parameters for distribution compensation for the restored feature map exist. On the other hand, fpps_restored_feature_refine_present_flag being 0 indicates that distribution parameters for distribution compensation (i.e., fpps_restored_feature_std and fpps_restored_feature_mean) are not present in the FPPS.

In Table 3, fpps_reduced_feature_refine_present_flag may indicate whether distribution parameters for distribution compensation for the restored reduced feature map are present. For example, when fpps_reduced_feature_refine_present_flag is 1, fpps_reduced_feature_std and fpps_reduced_feature_mean may be present in the FPPS. Additionally, if fsps_reduced_feature_refine_enable_flag in FSPS indicates that distribution compensation for the restored reduced feature map is allowed, and fpps_reduced_feature_refine_present_flag in FPPS is 1, then fpps_reduced_feature_std and fpps_reduced_feature_mean must be encoded/decoded.

Distribution compensation for the restored reduced feature map may be performed based on distribution parameters decoded from FPPS.

Conversely, fpps_reduced_feature_refine_present_flag being 0 indicates that the distribution parameters for distribution compensation (i.e., fpps_reduced_feature_std and fpps_reduced_feature_mean) are not present in FPPS.

Meanwhile, fpps_reduced_feature_std represents the standard deviation for performing distribution compensation on the restored reduced feature map. Additionally, fpps_reduced_feature_mean represents the mean value for performing distribution compensation on the restored reduced feature map.

Meanwhile, in FSPS, even if the value of the flag indicating whether distribution compensation is allowed (e.g., fsps_restored_feature_refine_enable_flag or fsps_reduced_feature_refine_enable_flag) is set to 1, if the value of the flag indicating whether distribution parameters are present in FPPS (e.g., fpps_restored_feature_refine_present_flag or fpps_reduced_feature_refine_present_flag) is 0, a problem may occur in which the decoder cannot determine which distribution parameter to use for distribution compensation.

To address such problems, the present disclosure proposes a method for transmitting distribution parameters in FPPS without using a flag indicating whether a distribution parameter is present (e.g., fppsrestored_feature_refinepresentflag or fppspreduced_feature_refinnepresentflag).

Table 4 shows an example of transmitting distribution parameters in FPPS without a flag indicating whether a distribution parameter is present, according to one embodiment of the present disclosure.

TABLE 4

| | Descriptor |
|---|---|
| feature_pic_parameter_set_rbsp( ) { | |
| fpps_feature_pic_parameter_set_id | |
| fpps_feature_seq_parameter_set_id | |
| if( fsps_restored_feature_refine_enable_flag ) { | |
| fpps_restored_feature_std | bfloat(16) |
| fpps_restored_feature_mean | bfloat(16) |
| } | |
| if( fsps_reduced_feature_refine_enable_flag ) { | |
| fpps_reduced_feature_std | float(32) |
| fpps_reduced_feature_mean | float(32) |
| } | |
| ... | |
| rbsp_trailing_bits( ) | |
| } | |

As shown in the example in Table 4, when fsps_restored_feature_refine_flag signaled in the FSPS is 1, fpps_restored_feature_std and fpps_restored_feature_mean may be present in the FPPS for distribution compensation of the restored feature map.

Similarly, when fspsreduced_feature_refine_flag signaled in the FSPS is 1, fpps_reduced_feature_std and fpps_reduced_feature_mean may be present in the FPPS for distribution compensation of the restored reduced feature map.

As another example, distribution parameters for distribution compensation for the current FPPS may be derived from an FPPS that was encoded/decoded prior to the current FPPS.

Table 5 illustrates an FPPS structure containing information for identifying an FPPS that has the same distribution parameters as the current FPPS.

TABLE 5

| | Descriptor |
|---|---|
| feature_pic_parameter_set_rbsp( ) { | |
| fpps_feature_pic_parameter_set_id | |
| fpps_feature_seq_parameter_set_id | |
| if( fsps_restored_feature_refine_enable_flag ) { | |
| fpps_restored_feature_refine_present_flag | u(1) |
| if( fpps_restored_feature_refine_present_flag ) { | |
| fpps_restored_feature_std | bfloat(16) |
| fpps_restored_feature_mean | bfloat(16) |
| } | |
| else | |
| fpps_restored_feature_refine_reference_pps_id | u(6) |
| } | |
| if( fsps_reduced_feature_refine_enable_flag ) { | |
| fpps_reduced_feature_refine_present_flag | u(1) |
| if ( fpps_reduced_feature_refine_present_flag ) { | |
| fpps_reduced_feature_std | float(32) |
| fpps_reduced_feature_mean | float(32) |
| } | |
| else | |
| fpps_reduced_feature_refine_reference_pps_id | u(6) |
| } | |
| ... | |
| rbsp_trailing_bits( ) | |
| } | |

If a value of fsps_restored_feature_refine_enable_flag signaled in the FSPS is 1 and a value of fpps_restored_feature_refine_present_flag signaled in the current FPPS is 0, a syntax that identifies an FPPS among the FPPSs that were encoded/decoded prior to the current FPPS that has the same distribution parameters as the current FPPS may be encoded/decoded.

For example, fpps_restored_feature_pic_parameter_set_id that identifies the ID of one of the already encoded/decoded FPPSs may be encoded/decoded through the FPPS. Distribution compensation of the restored feature map referencing the current FPPS may be performed based on the distribution parameters (i.e., fpps_restored_feature_std, fpps_restored_feature_mean) transmitted from the FPPS having the ID indicated by the syntax fpps_restored_feature_pic_parameter_set_id.

Similarly, for example, if a value of fsps_reduced_feature_refine_enable_flag signaled in the FSPS is 1 and a value of fpps_reduced_feature_refine_present_flag signaled in the current FPPS is 0, a syntax identifying an FPPS among FPPSs encoded/decoded prior to the current FPPS that has the same distribution parameters as the current FPPS may be encoded/decoded.

For example, fpps_reduced_feature_pic_parameter_set_id, which specifies the ID of one of the already encoded/decoded FPPSs, may be encoded/decoded through the FPPS. Based on the distribution parameters (i.e., fpps_restored_feature_std, fpps_restored_feature_mean) transmitted from the FPPS having the ID indicated by the syntax fpps_reduced_feature_pic_parameter_set_id, distribution compensation may be performed on the restored reduced feature map referencing the current FPPS.

Meanwhile, instead of individually encoding/decoding the syntax fpps_reduced_feature_pic_parameter_set_id, which indicates the ID of the FPPS for distribution compensation of the restored feature map, and the syntax fpps_reduced_feature_pic_parameter_set_id, which indicates the ID of the FPPS for distribution compensation of the restored reduced feature map, a unified syntax fpps_feature_pic_parameter_set_id may be encoded/decoded. For example, if at least one of fpps_restored_feature_refine_present_flag or fpps_reduced_feature_refine_present_flag is 0, fpps_feature_pic_parameter_set_id may be encoded/decoded.

The distribution parameter for distribution compensation for the restored feature map and the distribution parameter for distribution compensation for the restored reduced feature map, respectively, may be derived by referring to the FPPS having the ID indicated by fpps_feature_pic_parameter_set_id.

For example, when fpps_restored_feature_refine_present_flag is 0, distribution compensation for the restored feature map may be performed using the distribution parameter of the FPPS having the ID indicated by fpps_feature_pic_parameter_set_id. Additionally, when fpps_reduced_feature_refine_present_flag is 0, distribution compensation for the restored reduced feature map may be performed using the distribution parameter of the FPPS having the ID indicated by fpps_feature_pic_parameter_set_id.

Meanwhile, when the value of fsps_restored_feature_refine_enable_flag signaled in the FSPS is 1, for at least one of a plurality of FPPSs referring to the FSPS, a distribution parameter for distribution compensation must be explicitly encoded/decoded. That is, for at least one of the plurality of FPPSs, the value of fpps_restored_feature_refine_present_flag must be set to 1, and fpps_restored_feature_std and fpps_restored_feature_mean should be explicitly signaled.

Similarly, when the value of fsps_reduced_feature_refine_enable_flag signaled in the FSPS is 1, for at least one of the plurality of FPPSs referring to the FSPS, a distribution parameter for distribution compensation must be explicitly encoded/decoded. That is, for at least one of the plurality of FPPSs, the value of fpps_reduced_feature_refine_present_flag must be set to 1, and fpps_reduced_feature_std and fpps_reduced_feature_mean should be explicitly signaled.

Meanwhile, the distribution parameters (i.e., fpps_reduced_feature_std and fpps_reduced_feature_mean) for distribution compensation of the restored reduced feature map are represented in 64 bits, and the distribution parameters (i.e., fpps_restored_feature_std and fpps_restored_feature_mean) for distribution compensation of the restored feature map may be represented in 32 bits. Meanwhile, fpps_restored_feature_refine_reference_pps_id or fpps_reduced_feature_refine_reference_pps_id, which indicate the ID of an FPPS having the same distribution parameters as the current FPPS, may be set to 6 bits, similar to the syntax fpps_feature_pic_parameter_set_id, which indicates the ID of current FPPS. Accordingly, signaling overhead may be reduced by encoding/decoding the ID of an FPPS having the same distribution parameters as the current FPPS instead of directly encoding/decoding the distribution parameters.

As another example, if the current FPPS does not have distribution parameters, distribution compensation may be performed using default distribution parameters.

Information indicating default distribution parameters may be encoded/decoded through the FSPS. Table 6 illustrates the structure of an FSPS containing default distribution parameters.

TABLE 6

| | Descriptor |
|---|---|
| feature_seq_parameter_set_rbsp ( ) { | |
| fsps_feature_seq_parameter_set_id | |
| ... | |
| fsps_restored_feature_refine_enable_flag | u(1) |
| if (fsps_restored_feature_refine_enable_flag) { | |
| fsps_restored_feature_default_std | bfloat(16) |
| fsps_restored_feature_default_mean | bfloat(16) |
| } | |
| fsps_reduced_feature_refine_enable_flag | u(1) |
| if (fsps_reduced_feature_refine_enable_flag) { | |
| fsps_reduced_feature_default_std | float(32) |
| fsps_reduced_feature_default_mean | float(32) |
| } | |
| ... | |
| rbsp_trailing_bits( ) | |
| } | |

In Table 6, fsps_restored_feature_default_std represents the default standard deviation for distribution compensation of the restored feature map, and fsps_restored_feature_default_mean represents the default mean value for distribution compensation of the restored feature map.

Additionally, fsps_reduced_feature_default_std represents the default standard deviation for distribution compensation of the restored reduced feature map, and fsps_reduced_feature_default_mean represents the default mean value for distribution compensation of the restored reduced feature map.

When a value of fpps_restored_feature_refine_present_flag signaled in the FPPS is 1, distribution compensation for the restored feature map may be performed using fpps_restored_feature_std and fpps_restored_feature_mean signaled in that FPPS.

On the other hand, if a value of fpps_restored_feature_refine_present_flag signaled by the FPPS is 0, distribution compensation for the restored feature map may be performed using fsps_restored_feature_default_std and fsps_restored_feature_default_mean signaled by the FSPS to which referred by the FPPS.

Similarly, if a value of fpps_reduced_feature_refine_present_flag signaled by the FPPS is 1, distribution compensation for the restored reduced feature map may be performed using fpps_reduced_feature_std and fpps_reduced_feature_mean signaled by the FPPS.

On the other hand, if a value of fpps_reduced_feature_refine_present_flag signaled in the FPPS is 0, distribution compensation for the restored reduced feature map may be performed using fsps_reduced_feature_default_std and fsps_reduced_feature_default_mean signaled in the FSPS to which referred by the FPPS.

Since distribution parameters are transmitted at the FSPS level instead of at the FPPS level, signaling overhead can be reduced.

The FSPS may be periodically transmitted in-band. For example, the FSPS may be transmitted for each intra picture. Alternatively, the FSPS may be transmitted out-of-band, or the FSPS may be predefined in a decoder.

When the FSPS is transmitted in-band, distribution parameters to be referenced by FPPSs may also be periodically updated according to a transmission period of the FSPS.

On the other hand, when the FSPS is transmitted out-of-band or when the FSPS is predefined in the decoder, it may be difficult to periodically or adaptively update default distribution parameters in the FSPS. This may prevent adaptive determination of distribution parameters of a current FPPS, thereby causing a degradation in encoding/decoding efficiency.

To address the above issue, distribution compensation using default distribution parameters signaled in the FSPS may be allowed only when the FSPS is transmitted in-band.

As another example, a flag indicating whether to apply distribution compensation may be encoded/decoded for each FPPS. That is, the flag indicating whether to apply distribution compensation may not be encoded/decoded only in the FSPS, but may also be encoded/decoded in the FPPS. Accordingly, whether distribution compensation is performed may be determined for each picture.

Table 7 shows an example of a flag indicating whether distribution compensation is performed being encoded/decoded through FPPS. [0223][Table 7]

TABLE 7

| | Descriptor |
|---|---|
| feature_pic_parameter_set_rbsp( ) { | |
| fpps_feature_pic_parameter_set_id | |
| fpps_feature_seq_parameter_set_id | |
| if( fsps_restored_feature_refine_enable_flag ) { | |
| fpps_restored_feature_refine_enable_flag | u(1) |
| if( fpps_restored_feature_refine_enable_flag ) { | |
| fpps_restored_feature_std | bfloat(16) |
| fpps_restored_feature_mean | bfloat(16) |
| } | |
| } | |
| if( fsps_reduced_feature_refine_enable_flag ) { | |
| fpps_reduced_feature_refine_enable_flag | u(1) |
| if ( fpps_reduced_feature_refine_enable_flag ) { | |
| fpps_reduced_feature_std | float(32) |
| fpps_reduced_feature_mean | float(32) |
| } | |
| } | |
| if(fsps_feature_channel_removal_flag) { | |
| fpps_channel_removal_enable_flag | u(1) |
| if( fpps_channel_removal_enable_flag ) | |
| for( i=0; i<fsps_reduced_feature_channel_count; i++ ) | |
| fpps_coded_channel[ i ] | u(1) |
| } | |
| rbsp_trailing_bits( ) | |
| } | |

As shown in the example illustrated in Table 7, fpps_restored_feature_refine_enable_flag may be encoded/decoded instead of fpps_restored_feature_refine_present_flag.

For example, fpps_restored_feature_refine_enable_flag being 1 indicates that distribution compensation is performed on the restored feature map. In this case, the FPPS may include distribution parameters (i.e., fpps_restored_feature_std and fpps_restored_feature_mean) for performing distribution compensation on the restored feature map.

Conversely, fpps_restored_feature_refine_enable_flag being 0 indicates that distribution compensation is not performed on the restored feature map. In this case, the FPPS may not include distribution parameters for performing distribution compensation on the restored feature map.

Meanwhile, if fpps_restored_feature_refine_enable_flag is not present in the FPPS, the decoder may infer its value as 0.

Similarly, fpps_reduced_feature_refine_enable_flag may be encoded/decoded instead of fpps_reduced_feature_refine_present_flag.

For example, fpps_reduced_feature_refine_enable_flag being 1 indicates that distribution compensation is performed on the restored reduced feature map. In this case, the FPPS may include distribution parameters (i.e., fpps_reduced_feature_std and fpps_reduced_feature_mean) for performing distribution compensation on the restored reduced feature map.

Conversely, fpps_reduced_feature_refine_enable_flag being 0 indicates that distribution compensation is not performed on the restored reduced feature map. In this case, the FPPS may not include a distribution parameter for performing distribution compensation on the reconstructed reduced feature map.

Meanwhile, if the fpps_reduced_feature_refine_enable_flag is not present in the FPPS, the decoder may infer its value as 0.

For other encoding/decoding tools as well as distribution compensation, a flag indicating whether the tool should be invoked may be encoded/decoded instead of a flag indicating the presence of a parameter.

For example, as shown in the example in Table 7, instead of the flag fpps_channel_removal_present_flag, which indicates whether a parameter is present to restore the number of channels in the restored reduced feature map to its original number, the flag fpps_channel_removal_enable_flag, which indicates whether to restore the number of channels in the restored reduced feature map to its original number, may be encoded/decoded.

Here, a value of 1 for fpps_channel_removal_enable_flag indicates that channel restoration is performed on the restored reduced feature map. In this case, the restoration process for the discarded channels can be performed. On the other hand, a value of 0 for fpps_channel_removal_enable_flag indicates that channel removal for the feature map was not performed, and accordingly, channel restoration for the restored reduced feature map is not performed either.

Meanwhile, if fpps_channel_removal_enable_flag is not present in the FPPS, the decoder may infer its value as 0.

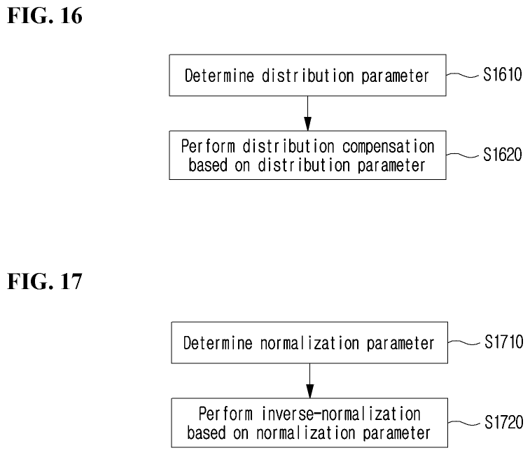

FIG. 16 is a flowchart of a process for performing distribution compensation on a restored feature map or a restored reduced feature map in a decoder according to an embodiment of the present disclosure.

In the decoder, a distribution parameter for distribution compensation may be determined S1610. Based on at least one of the embodiments described above, a distribution parameter for distribution compensation may be determined.

Based on the determined distribution parameter, distribution compensation may be performed on the restored feature map or the restored reduced feature map S1620.

### Embodiment 2) Encoding/Decoding of Normalization Parameters

The reduced feature map normalization unit may perform normalization based on the maximum and minimum values of the input reduced feature map yₚ. At this time, information indicating the maximum and minimum values used for normalization may be encoded and signaled to a decoder. Specifically, the reduced feature map normalization unit may perform normalization on the reduced feature map based on Equation 12.

$${y}_{n} = max ( min ( \frac{{y}_{p} - {y}_{p , min}}{{y}_{p , max} - {y}_{p , min}} , 0 ) , 1 ) \qquad [ Equation 12 ]$$

Among the feature values in the reduced feature map, the maximum value y_{p,max} and the minimum value y_{p,min} may differ depending on whether encoding is performed in All-Intra mode. For example, as in the examples of Equations 13 and 14, when the encoding mode is All-Intra mode, the maximum value y_{p,max} and the minimum value y_{p,min} may be determined by considering only the current picture.

On the other hand, when the encoding mode is not All-Intra mode, the smaller of the minimum value y̅_{p,min} used in the previous picture and the minimum value of the current picture may be determined as the maximum value y_{p,min}, and the larger of the maximum value y̅_{p,max} used in the previous picture and the maximum value of the current picture may be determined as the maximum value y_{p,max}.

$$if type == {}^{‵} {video}^{′} , {y}_{p , min} = min ( {\overline{y}}_{p , min} , min ( {y}_{p} ) ) , \qquad [ Equation 13 ]$$

$$else , min ( {y}_{p} )$$

$$if type == {}^{‵} {video}^{′} , {y}_{p , max} = min ( {\overline{y}}_{p , max} , max ( {y}_{p} ) ) , \qquad [ Equation 14 ]$$

$$else , max ( {y}_{p} )$$

Meanwhile, the minimum value y̅_{p,min} and maximum value y̅_{p,max} used in the previous picture may be initialized whenever the intra picture is encoded/decoded.

In the reduced feature map inverse normalization unit, inverse normalization may be performed based on the maximum and minimum values signaled from the encoder.

Specifically, the reduced feature map inverse normalization unit may perform inverse normalization on the reduced feature map based on Equation 15.

$${y}_{n} = max ( min ( \frac{{y}_{p} - {y}_{p , min}}{{y}_{p , max} - {y}_{p , min}} , 0 ) , 1 ) \qquad [ Equation 15 ]$$

$${\hat{y}}_{p} = {\hat{y}}_{n} \times ( {\tilde{y}}_{p , max} - {\tilde{y}}_{p , min} ) + {\tilde{y}}_{p , min}$$

In Equation 15, y_{p,max} represents the maximum value signaled from the encoder, and \tilde{y}_{p,min} represents the minimum value signaled from the encoder.

Meanwhile, even when normalization is performed on a reduced feature map at an encoder, inverse normalization of the reduced feature map is not necessarily required at a decoder. Accordingly, the encoder may encode and signal information indicating whether inverse normalization should be performed on the reduced feature map.

Normalization parameters (e.g., maximum and minimum values) for performing inverse normalization of the reduced feature map may be encoded/decoded through a picture header (i.e., FPH, Feature Picture Header).

Table 8 shows an example of normalization parameters being encoded/decoded through the FPH.

TABLE 8

| | Descriptor |
|---|---|
| feature_pic_header_rbsp( ) { | |
| fph_feature_pic_parameter_set_id | ue(v) |
| fph_picture_order_count_value | i(32) |
| if( !fsps_reduced_feature_refine_enable_flag ) { | |
| fph_updated_maximum_feature_value | float(32) |
| fph_updated_minimum_feature_value | float(32) |
| } | |
| if ( fsps_temporal_upsampling_enable_flag ) { | |
| fph_inactive_upsampling_flag | u(1) |
| } | |
| rbsp_trailing_bits( ) | |
| } | |

In Table 8, fph_updated_maximum_feature_value represents the maximum value of the reduced feature map, and fph_updated_minimum_feature_value represents the minimum value of the reduced feature map.

Meanwhile, inverse normalization may be performed on the reduced feature map only when distribution compensation is not performed on the reduced feature map. Accordingly, as in the example in Table 8, fph_updated_maximum_feature_value and fph_updated_minimum_feature_value may be encoded/decoded via FPH only when fsps_reduced_feature_refine_enable_flag, which indicates whether distribution compensation is performed on the reduced feature map, is 0.

The maximum value fph_updated_maximum_feature_value and the minimum value fph_updated_minimum_feature_value may be represented in 32 bits. That is, in order to perform inverse normalization of the reduced feature map, 64 bits of data need to be encoded and decoded for each picture. As such, when normalization parameters are transmitted on a per-picture basis, there is a problem in that signaling overhead increases.

To address the above problem, the present disclosure proposes a method for encoding/decoding normalization parameters based on an update flag only when an update of the normalization parameters used in the previous frame is required.

Table 9 illustrates an FPH structure including a flag indicating whether an update of the maximum value is required and a flag indicating whether an update of the minimum value is required.

TABLE 9

| | Descriptor |
|---|---|
| feature_pic_header_rbsp( ) { | |
| fph_feature_pic_parameter_set_id | ue(v) |
| fph_picture_order_count_value | i(32) |
| if( !fsps_reduced_feature_refine_enable_flag ) { | |
| fph_min_update_flag | u(1) |
| fph_max_update_flag | u(1) |
| if (fph_min_update_flag) | |
| fph_updated_minimum_feature_value | float(32) |
| if (fph_max_update_flag) | |
| fph_updated_maximum_feature_value | float(32) |
| } | |
| if ( fsps_temporal_upsampling_enable_flag ) { | |
| fph_inactive_upsampling_flag | u(1) |
| } | |
| rbsp_trailing_bits( ) | |
| } | |

In Table 9, fph_min_update_flag indicates whether the maximum value needs to be updated, and fph_min_update_flag indicates whether the minimum value needs to be updated.

Specifically, fph_min_update_flag being 1 presents that the minimum value minReduced FeatureValue needs to be updated. In this case, the syntax fph_updated_minimum_feature_value indicating the minimum value may be encoded/decoded.

On the other hand, fph_min_update_flag being 0 represents that the minimum value does not need to be updated. In this case, inverse normalization of the reduced feature map may be performed using the minimum value minReducedFeatureValue of the previous picture. Additionally, when fph_min_update_flag is 0, fph_updated_minimum_feature_value is not present in the FPH.

In addition, fph_max_update_flag being 1 represents that the maximum value maxReducedFeatureValue needs to be updated. In this case, the syntax fph_updated_maximum_feature_value, which indicates the maximum value, may be encoded/decoded.

On the other hand, fph_max_update_flag being 0 indicates that the maximum value does not need to be updated. In this case, inverse normalization of the reduced feature map may be performed using the maximum value maxReducedFeatureValue of the previous picture.

Additionally, if fph_max_updateflag is 0, fphupdatedmaximum_feature_value is not present in the FPH.

Instead of encoding/decoding the flag fphmax_update_flag, which indicates whether the maximum value needs to be updated, and the flag fph_minupdate_flag, which indicates whether the minimum value needs to be updated, respectively, the flag fph_updatemin_orfmax flag, which indicates whether at least one of the maximum and minimum values needs to be updated, may be used.

Table 10 shows the FPH structure including fph_update_min_or_max_flag.

TABLE 10

| | Descriptor |
|---|---|
| feature_pic_header_rbsp( ) { | |
| fph_feature_pic_parameter_set_id | ue(v) |
| fph_picture_order_count_value | i(32) |
| if( !fsps_reduced_feature_refine_enable_flag ) { | |
| fph_update_min_or_max_flag | u(1) |
| if (fph_update_min_or_max_flag) { | |
| fph_update_min_xor_max_flag | u(1) |
| if (fph_update_min_xor_max_flag) | |
| fph_min_max_update_value | float(32) |
| else { | |
| fph_updated_maximum_feature_value | float(32) |
| fph_updated_minimum_feature_value | float(32) |
| } | |
| } | |
| } | |
| if ( fsps_temporal_upsampling_enable_flag ) { | |
| fph_inactive_upsampling_flag | u(1) |
| } | |
| rbsp_trailing_bits( ) | |
| } | |

In Table 9, the syntax fph_update_min_or_max_flag indicates whether at least one of the maximum and minimum values needs to be updated. Specifically, fph_update_min_or_max_flag being 0 indicates that neither the maximum nor the minimum value needs to be updated. In this case, the maximum and minimum values from the previous picture can be used as is. On the other hand, fph_update_min_or_max_flag being 1 indicates that at least one of the maximum and minimum values needs to be updated.

When fph_update_min_or_max_flag is 1, fph_update_min_xor_max_flag, which indicates whether only one of the maximum or minimum value needs to be updated, may be encoded/decoded. For example, fph_update_min_xor_max_flag being 0 indicates that both the maximum and minimum values need to be updated. In this case, both the syntax fph_updated_maximum_feature_value indicating the maximum value and the syntax fph_updated_minimum_feature_value indicating the minimum value may be encoded/decoded. On the other hand, fph_update_min_xor_max_flag being 1 indicates that an update is required for only one of the minimum or maximum values. In this case, the syntax fph_min_max_update_value indicating the updated minimum value or the updated maximum value may be encoded/decoded.

Meanwhile, a maximum value to be used for a current picture should be greater than or equal to a maximum value used for a previous picture, and a minimum value to be used for the current picture should be less than or equal to a minimum value used for the previous picture. Using this property, it may be determined whether fph_min_max_update_value indicates the maximum value or the minimum value.

For example, if fph_min_max_update_value is greater than the maximum value of the previous picture, fph_min_max_update_value may represent the updated maximum value. In this case, inverse normalization of the reduced feature map may be performed based on the minimum value of the previous picture and the maximum value indicated by fph_min_max_update_value.

On the other hand, if fph_min_max_update_value is not greater than the maximum value of the previous picture, fph_min_max_update_value may represent the updated minimum value. In this case, inverse normalization of the reduced feature map may be performed based on the minimum value indicated by fph_min_max_update_value and the maximum value of the previous picture.

In the above-described embodiments, it has been exemplified that an update flag is used to determine whether to use, as they are, the minimum value and the maximum value of a reduced feature map used in a previous picture, or to newly encode and decode the maximum value and/or the minimum value for a current picture.

However, if the current picture is a picture that allows random access, such as an IRAP (Intra Random Access Picture) picture, the minimum and maximum values of the reduced feature map used in the previous picture cannot be used. Here, an IRAP picture represents a picture that does not perform inter-prediction based on a reference picture. An IDR (Instantaneous Decoding Refresh) picture may be a kind of an IRAP picture, and an IDR picture may represent a picture that has no dependency on previous pictures. When an IDR picture is inserted, the picture buffer is initialized to an empty state.

Therefore, if the current picture is an IRAP picture, parameters for the inverse normalization of the reduced feature map must be transmitted. That is, when the current picture is an IRAP picture, the encoding/decoding of the flag indicating whether to update the normalization parameter may be omitted, and the maximum and minimum values for inverse normalization should be explicitly encoded/decoded.

Tables 11 and 12 show examples where the update flag is encoded/decoded only when the current picture is not an IRAP picture.

TABLE 11

| | Descriptor |
|---|---|
| feature_pic_header_rbsp( ) { | |
| fph_feature_pic_parameter_set_id | ue(v) |
| fph_picture_order_count_value | i(32) |
| if( !fsps_reduced_feature_refine_enable_flag ) { | |
| if (CurrentPictureType != IRAP_PICTURE) | |
| { | |
| fph_min_update_flag | u(1) |
| fph_max_update_flag | u(1) |
| if (fph_min_update_flag) | |
| fph_updated_minimum_feature_value | float(32) |
| if (fph_max_update_flag) | |
| fph_updated_maximum_feature_value | float(32) |
| } | |
| else { | |
| fph_updated_minimum_feature_value | float(32) |
| fph_updated_maximum_feature_value | float(32) |
| } | |
| } | |
| ... | |
| rbsp_trailing_bits( ) | |
| } | |

TABLE 12

| | Descriptor |
|---|---|
| feature_pic_header_rbsp( ) { | |
| fph_feature_pic_parameter_set_id | ue(v) |
| fph_picture_order_count_value | i(32) |
| if( !fsps_reduced_feature_refine_enable_flag ) { | |
| if (CurrentPictureType != IRAP_PICTURE) | |
| { | |
| fph_update_min_or_max_flag | u(1) |
| if (fph_update_min_or_max_flag) { | |
| fph_update_min_xor_max_flag | u(1) |
| if (fph_update_min_xor_max_flag) | |
| fph_min_max_update_value | float(32) |
| else { | |
| fph_updated_maximum_feature_value | float(32) |
| fph_updated_minimum_feature_value | float(32) |
| } | |
| else { | |
| fph_updated_minimum_feature_value | float(32) |
| fph_updated_maximum_feature_value | float(32) |
| } | |
| } | |
| ... | |
| rbsp_trailing_bits( ) | |
| } | |

As shown in the example illustrated in Table 11, the flag fph_min_update_flag, indicating whether a minimum value needs to be updated, and the flag fph_max_update_flag, indicating whether a maximum value needs to be updated, may be encoded/decoded only when the current picture is not an IRAP picture.

In this case, fph_min_update_flag being 0 indicates that a minimum value does not need to be updated. In this case, inverse normalization of the reduced feature map may be performed using the minimum value mixReducedFeatureValue used in the previous picture as is. Here, the minimum value used in the previous picture may be the minimum value determined by fph_updated_minimum_feature_value decoded for an IRAP picture, or the minimum value used in the immediately preceding picture.

Additionally, fph_max_update_flag being 0 indicates that a maximum value does not need to be updated. In this case, inverse normalization of the reduced feature map may be performed by using the maxReducedFeatureValue used in the previous picture as is. Here, the maximum value used in the previous picture may be the maximum value determined by fph_updated_maximum_feature_value decoded for an IRAP picture, or the maximum value used in the immediately preceding picture.

If the current picture is an IRAP picture, the encoding/decoding of fph_min_update_flag and fph_max_update_flag may be omitted, and the syntax indicating the minimum value fph_updated_minimum_feature_value and the syntax indicating the maximum value fph_updated_maximum_feature_value may be encoded/decoded.

Alternatively, as in the example shown in Table 12, a flag fph_update_min_or_max_flag indicating whether at least one of the minimum or maximum values needs to be updated may be encoded/decoded only when the current picture is not an IRAP picture. If the current picture is an IRAP picture, the encoding/decoding of fph_update_min_or_max_flag may be omitted, and the syntax fph_updated_minimum_feature_value indicating the minimum value and the syntax fph_updated_maximum_feature_value indicating the maximum value should be encoded/decoded.

A flag indicating whether the current picture is an IRAP picture may be encoded/decoded. For example, in the Feature Picture Header (FPH), a flag fcm_irap_feature_picture_flag indicating whether the current picture is an IRAP picture may be encoded/decoded. A fcm_irap_feature_picture_flag of 1 indicates that the current picture is an IRAP picture, while a fcm_irap_feature_picture_flag of 0 indicates that the current picture is not an IRAP picture.

Alternatively, the NAL unit type may be used to determine whether an FPH corresponds to an IRAP picture. For example, a NAL unit type (e.g., FPH_NUT_IRAP) may be defined to indicate the FPH of an IRAP picture. Depending on whether the syntax fcm_nal_unit type, which indicates the NAL unit type encoded/decoded via the NAL unit header, indicates the FPH of an IRAP picture (i.e., FPH_NUT_IRAP), whether the corresponding FPH corresponds to an IRAP picture may be determined.

Alternatively, when a NAL unit type is FPH, a flag fuh_rap_flag indicating whether a current picture is a random access picture may be additionally encoded/decoded through a NAL unit header. When the fuh_rap_flag is equal to 1, it indicates that the current picture is a random access picture (i.e., an IRAP picture), and when the fuh_rap_flag is equal to 0, it indicates that the current picture is not a random access picture.

Meanwhile, Tables 11 and 12 may be modified as shown in the following Tables 13 and 14.

TABLE 13

| | Descriptor |
|---|---|
| feature_pic_header_rbsp( ) { | |
| fph_feature_pic_parameter_set_id | ue(v) |
| fph_picture_order_count_value | i(32) |
| if( !fsps_reduced_feature_refine_enable_flag ) { | |
| if (!fuh_rap_flag) { | |
| fph_min_update_flag | u(1) |
| fph_max_update_flag | u(1) |
| if (fph_min_update_flag) | |
| fph_updated_minimum_feature_value | float(32) |
| if (fph_max_update_flag) | |
| fph_updated_maximum_feature_value | float(32) |
| } | |
| else { | |
| fph_updated_minimum_feature_value | float(32) |
| fph_updated_maximum_feature_value | float(32) |
| } | |
| } | |
| ... | |
| rbsp_trailing_bits( ) | |
| } | |

TABLE 14

| | Descriptor |
|---|---|
| feature_pic_header_rbsp( ) { | |
| fph_feature_pic_parameter_set_id | ue(v) |
| fph_picture_order_count_value | i(32) |
| if( !fsps_reduced_feature_refine_enable_flag ) { | |
| if (!fuh_rap_flag) { | |
| fph_update_min_or_max_flag | u(1) |
| if (fph_update_min_or_max_flag) { | |
| fph_update_min_xor_max_flag | u(1) |
| if (fph_update_min_xor_max_flag) | |
| fph_min_max_update_value | float(32) |
| else { | |
| fph_updated_maximum_feature_value | float(32) |
| fph_updated_minimum_feature_value | float(32) |
| } | |
| else { | |
| fph_updated_minimum_feature_value | float(32) |
| fph_updated_maximum_feature_value | float(32) |
| } | |
| } | |
| ... | |
| rbsp_trailing_bits( ) | |
| } | |

In Tables 13 and 14, it is exemplified that whether to encode/decode the update flag is determined by referring to fuh_rap_flag.

It may also be determined whether the current picture is an IRAP picture based on the POC. For example, among the pictures decoded in the reduced feature map decoding unit, if the picture having the POC indicated by fph_picture_order_count_value in the FPH is an IRAP picture, it may be determined that the picture to be restored is an IRAP picture.

Normalization and inverse normalization may be performed using the minimum and maximum values of the reduced feature map. For example, in the reduced feature map normalization unit, normalization may be performed based on Equations 12 to 14, and in the reduced feature map inverse normalization unit, inverse normalization may be performed based on Equation 15.

As another example, normalization and inverse normalization of the reduced feature map may be performed based on the absolute maximum value. The absolute maximum value represents the larger of an absolute value of a minimum value and an absolute value of a maximum value. For example, the absolute maximum value may be derived according to the following equation 16.

$${y}_{p , absmax} = max ( \vert {y}_{p , min} \vert , \vert {y}_{p , max} \vert ) \qquad [ Equation 16 ]$$

Normalization and inverse normalization may be performed by setting the absolute maximum value as the maximum value and the absolute maximum value with a negative sign as the minimum value. For example, in the reduced feature map normalization process, normalization may be performed based on the mathematical equation 17, and in the reduced feature map inverse normalization process, inverse normalization may be performed based on the following equation 18.

$${y}_{n} = max ( min ( \frac{1}{2} \times ( \frac{{y}_{p}}{{y}_{p , absmax}} + 1 ) , 0 ) , 1 ) \qquad [ Equation 17 ]$$

$${\hat{y}}_{p} = {\hat{y}}_{n} \times ( {\tilde{y}}_{p , absmax} - ( - {\tilde{y}}_{p , absmax} ) ) + ( - {\tilde{y}}_{p , absmax} ) = 2 \times {\hat{y}}_{n} \times {\tilde{y}}_{p , absmax} - {\tilde{y}}_{p , absmax} \qquad [ Equation 18 ]$$

To perform denormalization based on the absolute maximum value, the absolute maximum value should be signaled. In this case, the encoding/decoding method of the normalization parameter based on the update flag described above can also be used to encode/decode the absolute maximum value.

For example, through the update flag, the absolute maximum value may be encoded/decoded only when the absolute maximum value used in the previous picture needs to be updated.

Table 15 shows an example where the encoding/decoding of the absolute maximum value is determined based on the update flag.

TABLE 15

| | Descriptor |
|---|---|
| feature_pic_header_rbsp( ) { | |
| fph_feature_pic_parameter_set_id | ue(v) |
| fph_picture_order_count_value | i(32) |
| if( !fsps_reduced_feature_refine_enable_flag ) { | |
| fph_absmax_update_flag | u(1) |
| if (fph_absmax_update_flag) | |
| fph_updated_absolute_maximum_feature_value | float(32) |
| } | |
| ... | |
| rbsp_trailing_bits( ) | |
| } | |

In Table 15, fph_absmax_update_flag indicates whether the absolute maximum value needs to be updated. For example, fph_absmax_update_flag being 1 indicates that the absolute maximum value needs to be updated. In this case, the syntax fph_updated_absolute_maximum_feature_value, which indicates the absolute maximum value, may be encoded/decoded.

Conversely, fph_absmax_update_flag being 0 indicates that the absolute maximum does not need to be updated. In this case, the absolute maximum value used in the previous picture may be used as is, and inverse normalization of the reduced feature map may be performed. Additionally, when fph_absmax_update_flag is 0, fph_updated_absolute_maximum_feature_value is not present in the FPH.

Only when the current picture is not an IRAP picture, the fph_absmax_update_flag, which indicates whether the absolute maximum value needs to be updated, may be encoded/decoded.

Table 16 shows an example where the encoding/decoding of the update flag is determined based on whether the current picture is an IRAP picture.

TABLE 16

| | Descriptor |
|---|---|
| feature_pic_header_rbsp( ) { | |
| fph_feature_pic_parameter_set_id | ue(v) |
| fph_picture_order_count_value | i(32) |
| if( !fsps_reduced_feature_refine_enable_flag ) { | |
| if (!fuh_rap_flag) { | |
| fph_absmax_update_flag | u(1) |
| if (fph_absmax_update_flag) | |
| fph_updated_absolute_maximum_feature_value | float(32) |
| } | |
| else | float(32) |
| fph_updated_absolute_maximum_feature_value | |
| ... | |
| rbsp_trailing_bits( ) | |
| } | |

As in the example in Table 16, fph_absmax_update_flag, which indicates whether the absolute maximum value needs to be updated, may be encoded/decoded only when fuh_rap_flag signaled in the NAL unit header is 0 (i.e., when the current picture is not an IRAP picture).

FIG. 17 is a flowchart of a process for performing inverse normalization on a reduced feature map restored in a decoder according to an embodiment of the present disclosure.

In the decoder, normalization parameters for performing inverse normalization may be determined S1710.

Normalization parameters for performing denormalization may be determined based on at least one of the embodiments described above.

Based on the determined normalization parameters, inverse normalization may be performed on the restored reduced feature map S1720.

According to the present disclosure, an improved encoding/decoding method for distribution parameters and/or normalization parameters may be provided.

According to the present disclosure, in a feature map encoding/decoding process, encoding/decoding efficiency can be improved by reusing distribution parameters and/or normalization parameters of a previous picture.

The effects that may be obtained from the present disclosure are not limited to the effects mentioned above, and other effects not mentioned herein may be clearly understood by those skilled in the art from the above description.

A name of syntax elements introduced in the above-described embodiments is only temporarily given to describe embodiments according to the present disclosure. Syntax elements may be referred to as names different from those proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof. At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method of decoding a feature map, comprising:
restoring a truncated reduced feature map by performing format inverse-conversion on a picture decoded from a bitstream; and
restoring a feature map from the truncated reduced feature map,
wherein the format inverse-conversion comprises at least one of an inverse-normalization or a distribution compensation on a decoded picture.

2. The method of claim 1, wherein the inverse-normalization is performed based on a normalization parameter, and
wherein the normalization parameter comprises a maximum value and a minimum value of feature values.

3. The method of claim 2, wherein a first update flag indicates whether the normalization parameter needs to be updated is decoded from the bitstream.

4. The method of claim 3, wherein in response to the first update flag indicating that the normalization parameter does not need to be updated, a normalization parameter of a previous picture is used as the normalization parameter of the decoded picture.

5. The method of claim 3, wherein in response to the first update flag indicating that the normalization parameter needs to be updated, a second update flag indicating whether only one of the maximum value and the minimum value needs to be updated is decoded from the bitstream, and
wherein in response to the second update flag indicating that only one of the maximum value and the minimum value needs to be updated, information specifying an updated value is further decoded from the bitstream.

6. The method of claim 5, wherein in response to the updated value is greater than a maximum value of a previous picture, the updated value is set as an updated maximum value, and
wherein in response to the updated value is not greater than the maximum value of the previous picture, the updated value is set as an updated minimum value.

7. The method of claim 2, wherein each of a maximum value update flag indicates whether the maximum value needs to be updated and a minimum value update flag indicates whether the minimum value needs to be updated is decoded from the bitstream.

8. The method of claim 7, wherein the maximum value update flag and the minimum value update flag are decoded from the bitstream when the decoded picture is not random access picture.

9. The method of claim 7, wherein in response to the maximum update flag indicating that the maximum value does not need to be updated, the inverse normalization is performed based on a maximum value of a previous picture, and
wherein in response to the maximum update flag indicating that the maximum value needs to be updated, information indicating an updated maximum value is additionally decoded, and the inverse normalization is performed based on a maximum value indicated by the information.

10. The method of claim 7, wherein in response to the minimum update flag indicating that the minimum value does not need to be updated, the inverse normalization is performed based on a minimum value of a previous picture, and
wherein in response to the minimum update flag indicating that the minimum value needs to be updated, information indicating an updated minimum value is additionally decoded, and the inverse normalization is performed based on a minimum value indicated by the information.

11. The method of claim 2, wherein the maximum value and the minimum value have equal absolute values and opposite signs.

12. The method of claim 1, wherein the distribution compensation is performed based on a distribution parameter, and
wherein the distribution parameter comprises a mean value and a standard deviation of feature values.

13. The method of claim 12, wherein in response to a first distribution compensation flag decoded from an FSPS (Feature Sequence Parameter Set) indicating that the distribution compensation is performed, a distribution compensation flag indicating whether the distribution compensation is performed or not is further decoded from an FPPS (Feature Picture Parameter Set).

14. The method of claim 13, wherein in response to the second distribution compensation flag indicates that the distribution compensation is performed, mean value information indicating the mean value and standard deviation information indicating the standard deviation are further decoded.

15. The method claim 11, wherein in response to a first distribution compensation flag decoded from an FSPS (Feature Sequence Parameter Set) indicating that the distribution compensation is performed, a present flag indicating whether distribution compensation parameter information is present in an FPPS (Feature Picture Parameter Set) or not is decoded.

16. The method of claim 15, wherein in response to the present flag indicating that the distribution compensation parameter information is not present in the FPPS, the distribution compensation is performed based on a default distribution compensation.

17. A method of encoding a feature map, comprising:
generating an encoding target picture by performing format conversion on a reduced feature map; and
encoding the encoding target picture,
wherein the format conversion comprises at least one of distribution adjustment or normalization on the reduced feature map.

18. A non-transitory computer readable medium storing instruction when executed cause the computer to carry out:
generating an encoding target picture by performing format conversion on a reduced feature map; and
encoding the encoding target picture,
wherein the format conversion comprises at least one of distribution adjustment or normalization on the reduced feature map.
